(19) United States
(12) Patent Application Publication
(10) Pub. No.: US 2022/0120205 A1
(43) Pub. Date: Apr. 21, 2022

(54) Air Injection System for Engine and Control Method Thereof

(71) Applicants: Hyundai Motor Company, Seoul (KR); Kia Motors Corporation, Seoul (KR)

(72) Inventors: Hyuk Im, Suwon-si (KR); Ki Hoon Nam, Hwaseong-si (KR); Yeong Seop Park, Seoul (KR); Seung Mok Choi, Seoul (KR); Chun Sik Lee, Hwaseong-si (KR); Jin Nam Kim, Gunpo-si (KR)

(21) Appl. No.: 17/168,649

(22) Filed: Feb. 5, 2021

(30) Foreign Application Priority Data
Oct. 21, 2020 (KR) 10-2020-0136824

(51) Int. Cl. F01N 3/22; F01N 9/00

(52) U.S. Cl. CPC F01N 3/225; F01N 9/00

(57) ABSTRACT

An air injection system for an engine includes an exhaust flange formed in a cylinder head integrated with an exhaust manifold, wherein the exhaust manifold is coupled to the exhaust flange, an air injection nozzle provided on the cylinder head or the exhaust manifold, a valve configured to control air supplied to the air injection nozzle, and a controller configured to control the valve, wherein the controller is configured to control the valve and inject air through the air injection nozzle when an exhaust-gas temperature reaches a predetermined combustion temperature in an initial start stage of the engine.

### CROSS-REFERENCE TO RELATED APPLICATIONS

This application claims the benefit of Korean Patent Application No. 10-2020-0136824, filed Oct. 21, 2020, which application is hereby incorporated herein by reference.

### TECHNICAL FIELD

The present invention relates to an air injection system and a control method thereof.

### BACKGROUND

An engine uses a catalyst converter as an after-treatment device for purifying harmful substances in exhaust gas.

The catalyst converter should be heated above a predetermined temperature to perform a proper purifying function. Thus, efforts are being made to rapidly increase the catalyst temperature of the catalyst converter above light-off temperature (LOT) in the cold start of the engine and thereby minimize harmful substances discharged from the engine.

Recently, an integrated cylinder head with an exhaust manifold configured such that at least a portion of an exhaust manifold is integrated with a cylinder head of the engine has been developed.

In other words, the integrated cylinder head is configured such that at least some of the exhaust ports connected to respective combustion chambers are coupled to each other in the cylinder head and then communicate with the outside of the cylinder head. For instance, after all the exhaust ports are coupled in the cylinder head, they are connected to an external exhaust pipe through a single passage. Furthermore, in the case of the engine having four combustion chambers, two exhaust ports connected to each combustion chamber are connected in the cylinder head, and then communicate with the outside of the cylinder head via two passages.

For reference, in the case of the structure in which some exhaust ports are connected in the cylinder head and then multiple passages are opened to the outside of the cylinder head, a component coupled to the cylinder head should be provided with passages that are connected, respectively, to the passages opened to the outside of the cylinder head and the passages should be merged into one passage when they are coupled to the catalyst converter. Thus, although some components of the exhaust manifold are included in the cylinder head, this will be referred to as the ‘exhaust manifold’.

Here, a part of the cylinder head to which the exhaust manifold is coupled will be referred to as an ‘exhaust flange’.

Meanwhile, in the case of a structure in which all exhaust ports are merged into one in the cylinder head and then are opened to the outside of the cylinder head through only one passage, i.e. a structure in which only one passage is opened in the exhaust flange, the exhaust manifold is completely included in the cylinder head. Thus, a component coupled to the exhaust flange will be simply referred to as an ‘exhaust pipe’. However, in order to collectively call it together with the exhaust manifold used for the structure in which multiple passages are formed in the exhaust flange, the component coupled to the exhaust flange having only one passage will be also referred to as the ‘exhaust manifold’.

In other words, at least a portion of the exhaust manifold is included in the cylinder head. The exhaust manifold coupled to the exhaust flange of the cylinder head means both an exhaust-pipe type simply having one passage, and a type having a plurality of passages such that they are merged into one.

The foregoing is intended merely to aid in the understanding of the background of the present invention, and is not intended to mean that the present invention falls within the purview of the related art that is already known to those skilled in the art.

### SUMMARY

The present invention relates to an air injection system and a control method thereof. Particular embodiments relate to an air injection system and a control method thereof, intended to rapidly increase the temperature of a catalyst for purifying the exhaust gas of an engine.

Accordingly, embodiments of the present invention have been made keeping in mind problems occurring in the related art, and an embodiment of the present invention provides an air injection system for an engine and a control method thereof, in which secondary air can be more effectively and appropriately applied to the front of a catalyst converter in an engine having an integrated cylinder head with an exhaust manifold, thus rapidly increasing the temperature of a catalyst in the cold start of the engine, and eventually minimizing harmful substances discharged from the engine, and meeting various emission control requirements.

An embodiment of the present invention provides an air injection system for an engine, including an exhaust flange formed in an integrated cylinder head with an exhaust manifold, an exhaust manifold coupled to the exhaust flange, an air injection nozzle provided on the cylinder head or the exhaust manifold, a valve installed to control air supplied to the air injection nozzle, and a controller configured to control the valve, wherein the controller is configured to control the valve and inject air through the air injection nozzle, when an exhaust-gas temperature reaches a predetermined combustion temperature in an initial start stage of the engine.

When a plurality of exhaust ports is opened in the exhaust flange, the air injection nozzle may comprise a plurality of air injection nozzles to inject air into each of the passages connected to the plurality of exhaust ports, and the plurality of air injection nozzles may be installed to inject air from an exhaust valve of each combustion chamber to a location corresponding to the same exhaust-gas flow length.

The controller may be configured to calculate the exhaust-gas temperature in the initial stage of the start of the engine, from a temperature model including an engine rpm, an intake-air amount, ignition timing, an air-fuel ratio, an engine coolant temperature, and an ambient temperature.

The temperature model used by the controller may be configured to calculate the exhaust-gas temperature at a location where the air injection nozzle is provided.

The controller may be configured to determine the combustion temperature that is a temperature at which fuel components in exhaust gas may be burned by air injected from the air injection nozzle, depending on a displacement volume of the engine and the air-fuel ratio.

The controller may set a waiting time at which the exhaust-gas temperature calculated from the temperature model is expected to be equal to or greater than the combustion temperature, and when the waiting time has elapsed after the engine is started, it may be determined that the exhaust-gas temperature in the initial stage of the start of the engine reaches the combustion temperature.

An embodiment of the present invention provides a method of controlling an air injection system for an engine, the air injection system including a valve installed to control air supplied to an air injection nozzle provided in a cylinder head of the engine having an integrated cylinder head with an exhaust manifold or the exhaust manifold, and a controller configured to control the valve, the method including calculating, by the controller, the exhaust-gas temperature in an initial stage of the start of the engine and a predetermined combustion temperature, when the engine is started, determining, by the controller, that the exhaust-gas temperature is equal to or greater than the combustion temperature, and controlling the valve to inject air through the air injection nozzle, when the exhaust-gas temperature is equal to or greater than the combustion temperature.

The controller may be configured to calculate the exhaust-gas temperature in the initial stage of the start of the engine at a location where the air injection nozzle is provided, using a temperature model including an engine rpm, an intake-air amount, ignition timing, an air-fuel ratio, an engine coolant temperature, and an ambient temperature.

The controller may be configured to determine the combustion temperature, depending on a displacement volume of the engine and the air-fuel ratio.

The controller may set a waiting time at which the exhaust-gas temperature calculated from the temperature model is expected to be equal to or greater than the combustion temperature, and when the waiting time has elapsed after the engine is started, it may be determined that the exhaust-gas temperature in the initial stage of the start of the engine is equal to or greater than the combustion temperature, thus injecting air through the air injection nozzle.

According to an embodiment of the present invention, secondary air can be more effectively and appropriately applied to the front of a catalyst converter in an engine having an integrated cylinder head with an exhaust manifold, thus rapidly increasing the temperature of a catalyst in the cold start of the engine, and eventually minimizing harmful substances discharged from the engine, and meeting various emission control requirements.

### BRIEF DESCRIPTION OF THE DRAWINGS

The above and other objectives, features, and other advantages of embodiments of the present invention will be more clearly understood from the following detailed description when taken in conjunction with the accompanying drawings, in which:

FIG. 1 is a diagram illustrating an air injection system for an engine in accordance with a first embodiment of the present invention;

FIG. 2 is a diagram illustrating an air injection system for an engine in accordance with a second embodiment of the present invention;

FIG. 3 is a diagram illustrating an exhaust flange formed in a cylinder head in accordance with the first embodiment;

FIG. 4 is a graph comparing exhaust-gas temperatures at two exhaust ports formed in the exhaust flange of the first embodiment, with the passing of time after an engine is started;

FIG. 5 is a diagram illustrating an example in which an air injection nozzle is provided on an exhaust manifold in accordance with embodiments of the present invention; and

FIG. 6 is a flowchart illustrating a method of controlling an air injection system for an engine in accordance with embodiments of the present invention.

### DETAILED DESCRIPTION OF ILLUSTRATIVE EMBODIMENTS

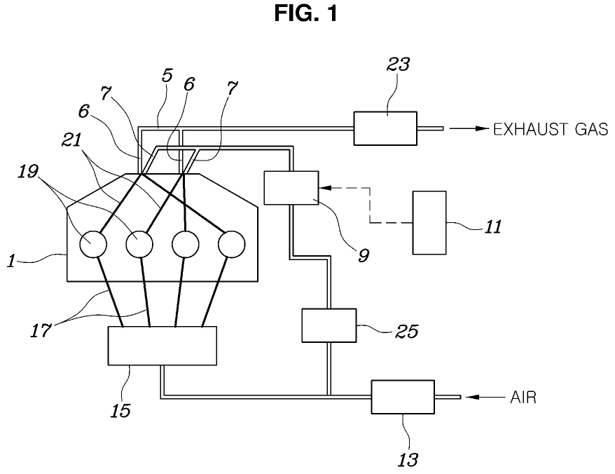

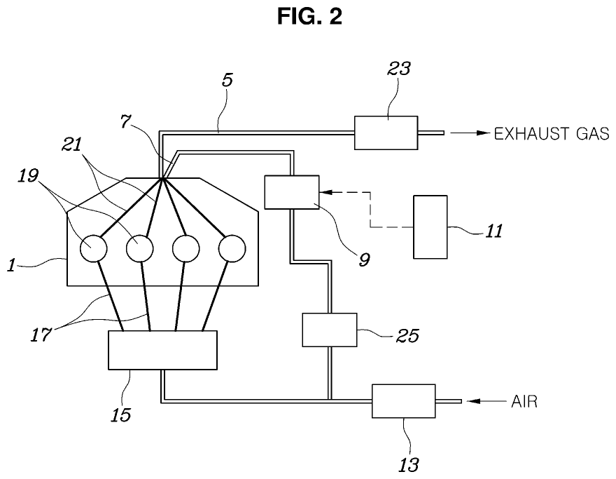

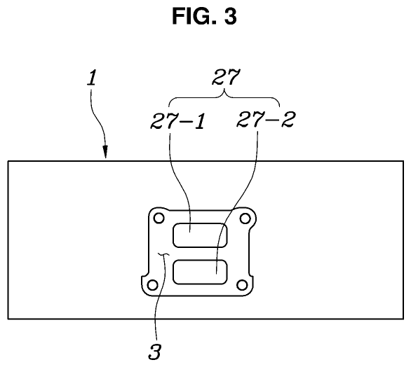

Referring to FIGS. 1 and 2, an air injection system for an engine according to embodiments of the present invention includes an exhaust flange 3 (see FIG. 3) formed in an integrated cylinder head 1 with an exhaust manifold 5, the exhaust manifold 5 coupled to the exhaust flange 3, an air injection nozzle 7 provided on the cylinder head 1 or the exhaust manifold 5, a valve 9 installed to control air supplied to the air injection nozzle 7, and a controller ii configured to control the valve 9.

Here, the controller 11 is configured to control the valve 9 and inject air through the air injection nozzle 7, when the exhaust-gas temperature reaches a predetermined combustion temperature in the initial start stage of the engine.

In other words, according to embodiments of the present invention, in order to rapidly increase the catalyst temperature of a catalyst converter in the initial stage of the cold-start of the engine, in the engine having the integrated cylinder head 1, air is injected into exhaust gas via the air injection nozzle 7, so that unburned hydrocarbon which is a fuel component in the exhaust gas is burned. After it is checked that the temperature reaches a combustion temperature by injecting the air into the unburned hydrocarbon in the exhaust gas, the air is injected.

In FIGS. 1 and 2, after the air in the atmosphere is filtered through an air cleaner 13, the air is supplied to each combustion chamber through a surge tank 15 and an intake manifold 17. The exhaust gas burned in each combustion chamber 19 passes through an exhaust port 21 connected to each combustion chamber 19, and flows through the exhaust manifold 5 to the catalyst converter 23.

Meanwhile, an air pump 25 performs a pumping function of sucking air through the air cleaner 13 and sending the air towards the air injection nozzle 7. The valve 9 is controlled by the controller 11 to supply or block compressed air supplied by the air pump 25 to the air injection nozzle 7.

In the first embodiment shown in FIGS. 1 and 3, a plurality of exhaust ports 27 is opened in the exhaust flange 3.

In other words, assuming that the combustion chambers are referred to as first, second, third and fourth chambers from the left of FIG. 1, after the exhaust port 21 connected to the first combustion chamber and the exhaust port 21 connected to the fourth combustion chamber are merged in the cylinder head 1, they communicate with an upper exhaust port 27-1 among the exhaust ports 27 of FIG. 3. After the exhaust port 21 connected to the second combustion chamber and the exhaust port 21 connected to the third combustion chamber are merged in the cylinder head 1, they communicate with a lower exhaust port 27-2 among the exhaust ports 27.

For reference, in FIG. 3, the upper exhaust port 27-1 and the lower exhaust port 27-2 are disposed on upper and lower locations. However, FIG. 1 illustrates that the exhaust ports 21 are disposed on left and right sides.

In this configuration, the air injection nozzle 7 may comprise a plurality of nozzles to inject air into each of passages 6 connected to the plurality of exhaust ports 27. The plurality of air injection nozzles 7 is installed to inject air from the exhaust valve of each combustion chamber 19 to a location corresponding to the same exhaust-gas flow length.

In other words, the locations of the air injection nozzles 7 are selected such that lengths measured along paths where exhaust gas flows from the exhaust valves of the first to fourth combustion chambers through each exhaust port 21 and the exhaust manifold 5 towards the catalyst converter 23 are the same.

The reason is as follows: the temperature of the exhaust gas discharged from each combustion chamber 19 varies depending on the length of the path where the exhaust gas flows. An embodiment of the present invention is configured to simultaneously supply air to the air injection nozzles 7, thus allowing the temperature of the exhaust gas to simultaneously reach the combustion temperature at all locations where the air injection nozzles 7 are installed.

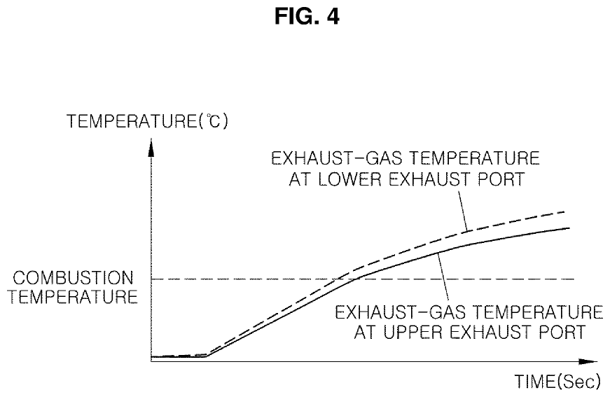

For reference, FIG. 4 is a graph comparing exhaust-gas temperatures at two exhaust ports formed in the exhaust flange of the first embodiment, with the passing of time after the engine is started. It is shown that time required for the exhaust-gas temperature in the upper exhaust port 27-1 to exceed the combustion temperature is longer than time required for the exhaust-gas temperature in the lower exhaust port 27-2 to exceed the combustion temperature. This is because the exhaust-gas flow distance from the first combustion chamber and the fourth combustion chamber to the upper exhaust port 27-1 in the engine structure of FIG. 1 is longer than the exhaust-gas flow distance from the second combustion chamber and the third combustion chamber to the lower exhaust port 27-2.

Of course, in the second embodiment shown in FIG. 2, all the exhaust ports 21 are merged into one in the cylinder head 1, and only one exhaust port 27 is formed in the exhaust flange 3. Since the exhaust manifold 5 connected thereto also has the shape of a pipe having only one passage, only one air injection nozzle 7 may be provided and be selectively provided on a side of the cylinder head 1 around the exhaust flange 3 or the exhaust manifold 5.

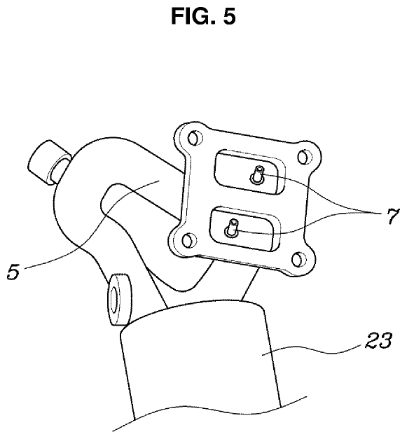

For reference, FIG. 5 illustrates the exhaust manifold 5 that may be coupled to the exhaust flange 3 shown in FIG. 3. In the drawing, the air injection nozzles 7 are provided on the exhaust manifold 5.

The controller 11 is configured to calculate the exhaust-gas temperature in the initial stage of the start of the engine, from a temperature model including an engine rpm, an intake-air amount, ignition timing, an air-fuel ratio, an engine coolant temperature, and an ambient temperature.

In other words, the temperature model is configured to output the exhaust-gas temperature using the engine rpm, the intake-air amount, the ignition timing, the air-fuel ratio, the engine coolant temperature, and the ambient temperature as input variables, and may be made in the form of an equation based on results of many experiments and analyses on a corresponding engine.

Alternatively, the temperature model is provided in the map of the exhaust-gas temperature depending on the input variables. The controller 11 may be configured to recognize a desired exhaust-gas temperature based on this map.

Of course, the temperature model is configured to calculate the exhaust-gas temperature at a location where the air injection nozzle 7 is provided.

The controller 11 is configured to determine the combustion temperature that is a temperature at which fuel components in the exhaust gas may be burned by the air injected from the air injection nozzle 7, depending on the displacement volume of the engine and the air-fuel ratio.

In other words, by performing many experiments and analyses on the corresponding engine at the combustion temperature, a mathematical model for determining the combustion temperature depending on the displacement volume of the engine and the air-fuel ratio may be provided or the map may be provided, so that the controller 11 may calculate the combustion temperature using the mathematical model or the map.

The controller 11 sets a waiting time at which the exhaust-gas temperature calculated from the temperature model is expected to be equal to or greater than the combustion temperature. When the waiting time has elapsed after the engine is started, it is determined that the exhaust-gas temperature in the initial stage of the start of the engine reaches the combustion temperature, so that the valve 9 is opened and thereby the air injection nozzle 7 injects the compressed air into the exhaust gas.

Of course, the controller 11 may be configured to directly open the valve 9, when the exhaust-gas temperature calculated from the temperature model directly compares with the combustion temperature and then the exhaust-gas temperature is equal to or greater than the combustion temperature.

As described above, the map of the open time according to the environmental conditions of the engine is previously prepared, and the valve 9 is opened for a time determined from the map, so that the air may be continuously injected into the exhaust gas via the air injection nozzle 7.

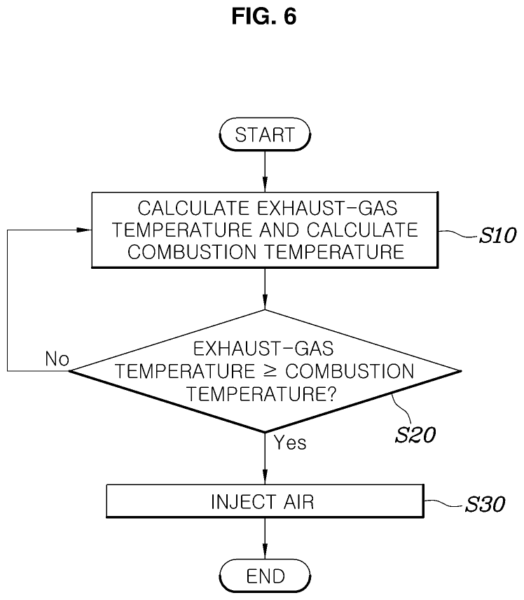

Referring to FIG. 6, a method of controlling an air injection system for an engine according to embodiments of the present invention includes a step S10 of calculating by the controller 11 the exhaust-gas temperature in the initial stage of the start of the engine and a predetermined combustion temperature, when the engine is started, a step S20 of determining by the controller ii that the exhaust-gas temperature is equal to or greater than the combustion temperature, and a step S30 of controlling the valve 9 to inject air through the air injection nozzle 7, when the exhaust-gas temperature is equal to or greater than the combustion temperature.

As described above, the controller 11 may calculate the exhaust-gas temperature in the initial stage of the start of the engine, at a location where the air injection nozzle 7 is provided, using the temperature model including the engine rpm, the intake-air amount, the ignition timing, the air-fuel ratio, the engine coolant temperature, and the ambient temperature.

Furthermore, the controller 11 may determine the combustion temperature, depending on the displacement volume of the engine and the air-fuel ratio.

The controller 11 sets a waiting time at which the exhaust-gas temperature calculated from the temperature model is expected to be equal to or greater than the combustion temperature. When the waiting time has elapsed after the engine is started, it is determined that the exhaust-gas temperature in the initial stage of the start of the engine reaches the combustion temperature, so that the air may be injected through the air injection nozzle 7.

Although the present invention was described with reference to specific embodiments shown in the drawings, it is apparent to those skilled in the art that the present invention may be changed and modified in various ways without departing from the scope of the present invention, which is described in the following claims.

What is claimed is:

1. An air injection system for an engine, the air injection system comprising:
an exhaust flange formed in a cylinder head integrated with an exhaust manifold, wherein the exhaust manifold is coupled to the exhaust flange;
an air injection nozzle provided on the cylinder head or the exhaust manifold;
a valve configured to control air supplied to the air injection nozzle; and
a controller configured to control the valve to inject air through the air injection nozzle when an exhaust-gas temperature reaches a predetermined combustion temperature in an initial start stage of the engine.

2. The air injection system of claim 1, wherein the air injection nozzle comprises a plurality of air injection nozzles so that when a plurality of exhaust ports is opened in the exhaust flange, the plurality of air injection nozzles can inject air into passages connected to each of the plurality of exhaust ports.

3. The air injection system of claim 2, wherein the plurality of air injection nozzles is configured to inject the air from an exhaust valve of each combustion chamber to a location corresponding to the same exhaust-gas flow length.

4. The air injection system of claim 1, wherein the controller is configured to calculate the exhaust-gas temperature in the initial start stage of the engine from a temperature model including an engine rpm, an intake-air amount, ignition timing, an air-fuel ratio, an engine coolant temperature, or an ambient temperature.

5. The air injection system of claim 4, wherein the temperature model used by the controller is configured to calculate the exhaust-gas temperature at a location where the air injection nozzle is provided.

6. The air injection system of claim 4, wherein the controller is configured to determine a combustion temperature that is a temperature at which fuel components in exhaust gas may be burned by air injected from the air injection nozzle, depending on a displacement volume of the engine and the air-fuel ratio.

7. The air injection system of claim 6, wherein the controller is configured to set a waiting time at which the exhaust-gas temperature calculated from the temperature model is expected to be equal to or greater than the combustion temperature, and when the waiting time has elapsed after the engine is started, the controller is configured to determine that the exhaust-gas temperature in the initial start stage of the engine has reached the combustion temperature.

8. The air injection system of claim 1, wherein the controller is configured to calculate the exhaust-gas temperature in the initial start stage of the engine from a temperature model including an engine rpm, an intake-air amount, ignition timing, an air-fuel ratio, an engine coolant temperature, and an ambient temperature.

9. The air injection system of claim 8, wherein the temperature model used by the controller is configured to calculate the exhaust-gas temperature at a location where the air injection nozzle is provided.

10. The air injection system of claim 8, wherein the controller is configured to determine a combustion temperature that is a temperature at which fuel components in exhaust gas may be burned by air injected from the air injection nozzle, depending on a displacement volume of the engine and the air-fuel ratio.

11. The air injection system of claim 10, wherein the controller is configured to set a waiting time at which the exhaust-gas temperature calculated from the temperature model is expected to be equal to or greater than the combustion temperature, and when the waiting time has elapsed after the engine is started, the controller is configured to determine that the exhaust-gas temperature in the initial start stage of the engine has reached the combustion temperature.

12. A method of controlling an air injection system for an engine, the air injection system comprising a valve to control air supplied to an air injection nozzle provided in an exhaust manifold or in a cylinder head of the engine having an integrated cylinder head with the exhaust manifold, and a controller to control the valve, the method comprising:
calculating an exhaust-gas temperature in an initial start stage of the engine and a predetermined combustion temperature when the engine is started;
determining that the exhaust-gas temperature is equal to or greater than the combustion temperature; and
controlling the valve to inject air through the air injection nozzle when the exhaust-gas temperature is equal to or greater than the combustion temperature.

13. The method of claim 12, further comprising calculating the exhaust-gas temperature in the initial start stage of the engine at a location where the air injection nozzle is provided using a temperature model including an engine rpm, an intake-air amount, ignition timing, an air-fuel ratio, an engine coolant temperature, or an ambient temperature.

14. The method of claim 13, further comprising determining the combustion temperature depending on a displacement volume of the engine and the air-fuel ratio.

15. The method of claim 14, further comprising:
setting a waiting time at which the exhaust-gas temperature calculated from the temperature model is expected to be equal to or greater than the combustion temperature;
when the waiting time has elapsed after the engine is started, determining that the exhaust-gas temperature in the initial start stage of the engine is equal to or greater than the combustion temperature; and
after determining that the exhaust-gas temperature in the initial start stage of the engine is equal to or greater than the combustion temperature, injecting the air through the air injection nozzle.

16. The method of claim 12, further comprising calculating the exhaust-gas temperature in the initial start stage of the engine at a location where the air injection nozzle is provided using a temperature model including an engine rpm, an intake-air amount, ignition timing, an air-fuel ratio, an engine coolant temperature, and an ambient temperature.

17. The method of claim i6, further comprising determining the combustion temperature depending on a displacement volume of the engine and the air-fuel ratio.

18. The method of claim 17, further comprising:
setting a waiting time at which the exhaust-gas temperature calculated from the temperature model is expected to be equal to or greater than the combustion temperature;
when the waiting time has elapsed after the engine is started, determining that the exhaust-gas temperature in the initial start stage of the engine is equal to or greater than the combustion temperature; and
after determining that the exhaust-gas temperature in the initial start stage of the engine is equal to or greater than the combustion temperature, the method further comprises injecting the air through the air injection nozzle.

19. A method comprising:
forming an exhaust flange in a cylinder head integrated with an exhaust manifold, wherein the exhaust manifold is coupled to the exhaust flange;
providing at least one air injection nozzle on the cylinder head or the exhaust manifold;
controlling air supplied to the air injection nozzle through a valve; and
controlling the valve and injecting the air through the air injection nozzle when an exhaust-gas temperature reaches a predetermined combustion temperature in an initial start stage of an engine.
